(19) United States
(12) Patent Application Publication
(10) Pub. No.: US 2023/0415109 A1
(43) Pub. Date: Dec. 28, 2023

(54) BLENDING TUBE

(71) Applicant: NANJING GENSCRIPT BIOTECH CO., LTD., Nanjing (CN)

(72) Inventors: Hao ZHANG, Nanjing (CN); Liwei SUN, Nanjing (CN); Jinwen WEI, Nanjing (CN); Yuehua QIAO, Nanjing (CN); Yu FANG, Nanjing (CN); Zhenbo SUN, Nanjing (CN); Zhun ZHANG, Nanjing (CN)

(73) Assignee: NANJING GENSCRIPT BIOTECH CO., LTD., Nanjing (CN)

(21) Appl. No.: 18/465,964

(22) Filed: Sep. 12, 2023

Related U.S. Application Data
(63) Continuation of application No. PCT/CN2022/085299, filed on Apr. 6, 2022.

(30) Foreign Application Priority Data
Apr. 6, 2021 (CN) 202110369584.X

(51) Int. Cl. B01F 29/00; B01F 29/15

(52) U.S. Cl. CPC B01F 29/40221; B01F 29/15; B01F 2101/44

(57) ABSTRACT

A blending tube (10), comprising: a tube body (20), the tube body (20) being used for accommodating a sample; and a first stirring member (30) and a second stirring member (40), which are arranged on an inner wall (200) of the tube body (20), wherein a width-to-thickness ratio of the first stirring member (30) is greater than a width-to-thickness ratio of the second stirring member (40).

### CROSS-REFERENCE TO RELATED APPLICATIONS

The present application is a Continuation of International Application No. PCT/CN2022/085299, filed on Apr. 6, 2022, which claims priority to Chinese patent application No. 202110369584. X, field on Apr. 6, 2021, which is incorporated herein by reference in its entirety.

### TECHNICAL FIELD

The present application relates to the field of mixing of substances, and in particular to a blending tube.

### BACKGROUND OF THE INVENTION

In the practice of bioengineering, it is usually necessary to mix two or more substances to obtain a new mixture or make two or more substances react adequately. The mixing effect of the substances will affect the quality of bioengineered products.

Therefore, there is an urgent need to provide a blending tube that can speed up mixing of the substances and effectively improve the mixing effect of the substances.

### SUMMARY

Some embodiments of the specification provide a blending tube, the blending tube including: a tube body, the tube body being used for accommodating a sample; and a first stirring member and a second stirring member, which are arranged on an inner wall of the tube body, wherein a width-to-thickness ratio of the first stirring member is greater than a width-to-thickness ratio of the second stirring member.

In some embodiments, the width-to-thickness ratio of the first stirring member is greater than 3.

In some embodiments, the first stirring member has a width within the range of 3.5 mm to 5 mm, and the first stirring member has a thickness within the range of 1 mm to 1.2 mm.

In some embodiments, the width-to-thickness ratio of the second stirring member is less than 1.5.

In some embodiments, the second stirring member has a width within the range of 1.6 mm to 1.9 mm, and the second stirring member has a thickness within the range of 1.2 mm to 1.4 mm.

In some embodiments, the first stirring member has a height within the range of 5 mm to 100 mm.

In some embodiments, the second stirring member has a height within the range of 10 mm to 100 mm.

In some embodiments, a gap is formed between the first stirring member and the inner wall of the tube body in a width direction.

In some embodiments, the gap has a length no greater than 10 mm.

In some embodiments, the inner wall of the tube body includes an inner side wall and an inner bottom wall hermetically connected to one end of the inner side wall; and the first stirring member is arranged on the inner bottom wall, and the second stirring member is arranged on the inner side wall.

In some embodiments, the bottom of the inner bottom wall is a flat face or an upwardly convex face, the upwardly convex face protruding towards the inside of the tube body.

In some embodiments, the bottom of the inner bottom wall is provided with a bulged portion protruding towards the inside of the tube body.

In some embodiments, there are two of the first stirring members and two of the second stirring members.

In some embodiments, the two first stirring members and the two second stirring members are symmetrically arranged with respect to a central axis of the tube body.

In some embodiments, a connecting line between the two first stirring members and a connecting line between the two second stirring members form an angle of 90 degrees.

In some embodiments, the first stirring member and the second stirring member are circumferentially arranged at intervals along the inner wall of the tube body.

In some embodiments, the first stirring member includes a first end and a second end, the first end being connected to the inner wall of the tube body, and the second end extending towards the center of the tube body.

### BRIEF DESCRIPTION OF THE DRAWINGS

The present application will be further illustrated by way of exemplary embodiments, and these exemplary embodiments will be described in detail with reference to the accompanying drawings. These embodiments are not restrictive, and in these embodiments, the same numerals represent the same structures, in which:

FIG. 1 is a schematic diagram of a part of a tube body according to some embodiments of the present application;

FIG. 2 is a schematic diagram of a blending tube according to some embodiments of the present application;

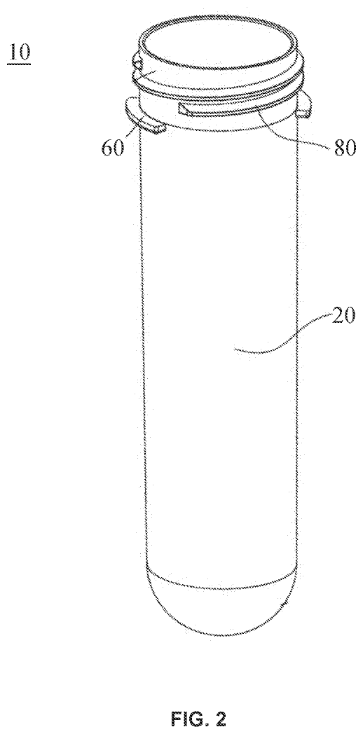

FIG. 3 is a top view of FIG. 2;

FIG. 4 is a schematic diagram of a part of a tube body according to other embodiments of the present application;

FIG. 5 is a schematic diagram of a part of a tube body according to other embodiments of the present application;

FIG. 6 is a perspective view of a blending tube according to other embodiments of the present application;

FIG. 7 is a schematic diagram of a blending tube according to other embodiments of the present application;

FIG. 8 is a schematic diagram of a part of a tube body according to other embodiments of the present application;

FIG. 9 is a schematic cross-sectional view of a blending tube according to some embodiments of the present application; and

FIG. 10 is a schematic cross-sectional view of a blending tube according to other embodiments of the present application.

Reference signs: Blending tube 10; Tube body 20; Inner wall 200; Inner side wall 210; Inner bottom wall 220; Bulged portion 221; First stirring member 30; Second stirring member 40; Gap 50; First anti-rotating portion 60; Second anti-rotating portion 70; and Thread 80.

### DETAILED DESCRIPTION OF THE INVENTION

For a clearer description of the technical solutions in the embodiments of the present application, a brief introduction will be given below for the accompanying drawings required for describing the embodiments. Apparently, the accompanying drawings in the following description show merely some embodiments of the present application, and those of ordinary skill in the art may still apply the present application to other similar scenarios according to these accompanying drawings without any creative effort. Unless obvious from the linguistic context or otherwise stated, the same reference signs in the drawings represent the same structure or operation.

As shown in the present application and the claims, the words “one”, “a”, “an” and/or “the” do not specifically refer to the singular, but may also include the plural, unless the context clearly indicates otherwise. Generally, the terms “including” and “comprising” only imply the inclusion of explicitly identified steps and elements, and these steps or elements do not constitute an exclusive list. A method or device may also include further steps or elements. The term “based on” means “at least partially based on”. The term “one embodiment” means “at least one embodiment”; the term “a further embodiment” means “at least one further embodiment”; and when the term “within the range of . . . ” indicates a numerical range, it includes both end values. For example, the range indicated by “within the range of 1.5 mm to 15 mm” includes both 1.5 mm and 15 mm in addition to the numerical values between 1.5 mm and 15 mm. Relevant definitions of other terms will be given in the following descriptions.

In the practice of bioengineering, it is usually necessary to mix two or more substances, and the purpose of mixing includes, but is not limited to, obtaining a new mixture or making the two or more substances react adequately. In some embodiments, the step of mixing two or more substances (i.e., samples) may include adding the two or more substances (i.e., samples) into a blending tube, and then rotating the blending tube using an external apparatus (e.g., a blending apparatus) or manually rotating the blending tube by an operator to cause centrifugal movement of the two or more substances in the blending tube, thereby achieving the purpose of mixing.

However, due to the different specific gravities of all the substances, when two or more substances are accommodated in the blending tube, they will be in different areas of the blending tube (e.g., a solid substance with a high specific gravity will accumulate mainly at the bottom of the blending tube, and a liquid substance with a low specific gravity will mainly occupy areas of the blending tube other than the bottom).

In some embodiments, an auxiliary stirring structure may be arranged in the blending tube to help improve the mixing effect. In some embodiments, the auxiliary stirring structure may include a stirring rib arranged on an inner wall of the blending tube. The use of the stirring rib allows the liquid substance in the blending tube to produce a vortex in the process of blending, and the vortex draws the liquid substance into the area where the solid substance is located to achieve mixing. In some embodiments, the auxiliary stirring structure may include a stirring blade arranged on an inner wall of the blending tube. In the process of blending, the stirring blade may be utilized to impact the substances to be blended and to scatter the substances clumping together so as to realize adequate mixing. In some embodiments, the auxiliary stirring structure may include both of a stirring blade and a stirring rib, which are arranged on an inner wall of the blending tube. The stirring blade is utilized to scatter the substances that clump together, and the stirring rib is utilized to produce a vortex, so that more adequate blending is achieved and the mixing effect is improved. In some embodiments, when comparing the stirring blade with the stirring rib, the width-to-thickness ratio of the stirring blade is greater than the width-to-thickness ratio of the stirring rib, and in other words, the stirring blade is thinner than the stirring rib. In some embodiments, when comparing the stirring blade with the stirring rib, the width of the stirring blade is greater than the width of the stirring rib, and in other words, the stirring blade is wider than the stirring rib.

When the blending tube provided by the present application is used for stirring and mixing, the stirring rib and the stirring blade may respectively impact and stir the substances in different areas of the tube body to cause more vigorous movement of the substances, so that the substances are mixed more adequately, which improves the mixing effect. The blending tube will be exemplarily described below with reference to the accompanying drawings.

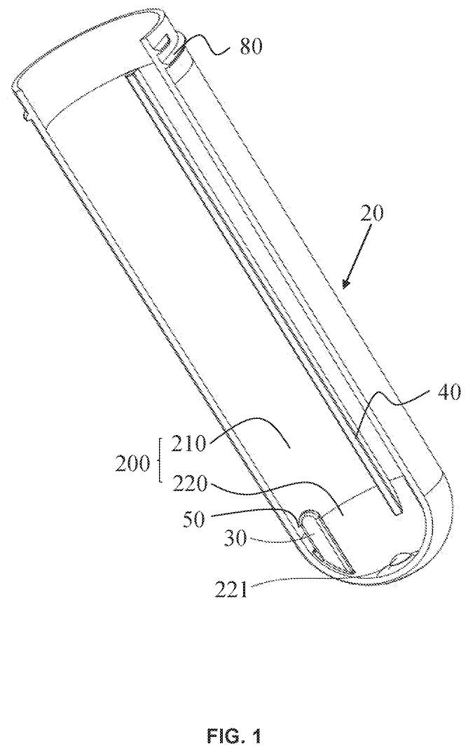

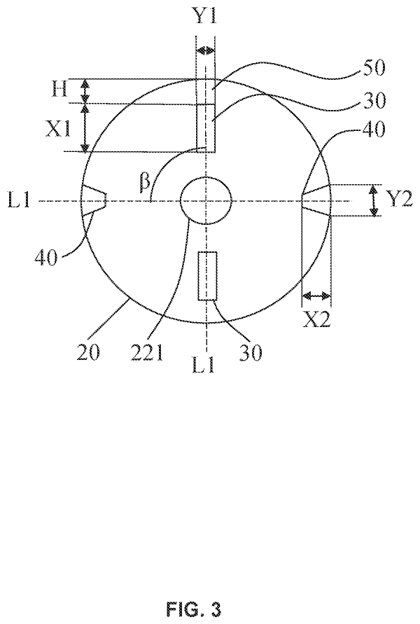

Referring to FIG. 1, in some embodiments, a blending tube 10 may include a tube body for accommodating a sample (not shown in the figure). An inner wall 200 of the tube body 20 is provided with a first stirring member 30 and a second stirring member 40. In some embodiments, the width-to-thickness ratio of the first stirring member 30 is greater than the width-to-thickness ratio of the second stirring member 40, so that the sample can be mixed and stirred more adequately, which improves the mixing effect. Further, in some embodiments, the width of the first stirring member 30 may be made greater than the width of the second stirring member 40, again to achieve the above effect. In some embodiments, the width of the stirring member (e.g., the first stirring member 30 and the second stirring member 40) refers to the dimension in a direction in which the stirring member extends from the inner wall of the tube body 20 to the inside of the tube body 20. For example, in FIG. 3, the first stirring member 30 has a width X1, and the second stirring member 40 has a width X2. The thickness of the stirring member refers to the distance between two side faces of the stirring member extending from the inner wall of the tube body 20 to the inside of the tube body 20. For example, in FIG. 3, the first stirring member 30 has a thickness Y1, and the second stirring member 40 has a thickness Y2. In some embodiments, the ratio of width X1 to thickness Y1 of the first stirring member 30 is greater than the ratio of width X2 to thickness Y2 of the second stirring member 40, so the first stirring member 30 is thinner than the second stirring member 40. Therefore, the first stirring member 30 may also be called a stirring blade, and the second stirring member 40 may also be called a stirring rib.

In the present application, the blending tube 10 may also serve as a vessel for sample mixing. The so-called sample mixing may be understood as mixing two or more substances contained in the sample. In some embodiments, the mixing of two or more substances may include mixing of a solid substance with a liquid substance and mixing of a liquid substance with a liquid substance. For example, Escherichia coli sludge (i.e., a solid substance obtained by centrifugal separation of an Escherichia coli culture solution) is mixed with a cell resuspension solution. For the ease of description, unless otherwise specified, the present application is illustrated by taking mixing of the Escherichia coli sludge and the cell resuspension solution as an example.

It should be noted that one or more embodiments of the present application are described by taking only one use of the blending tube 10 as an example. It can be understood that the application scenario of the blending tube 10 is not limited thereto. For example, the blending tube 10 may serve as a storage container for storing the sample. For example, the blending tube may serve as a vessel for centrifugal separation, which cooperates with a centrifugal apparatus for centrifugal separation of the substances with different specific gravities stored in the blending tube 10. Furthermore, the blending tube 10 may be called a centrifugal tube when serving as a vessel for centrifugal separation. For example, the blending tube 10 may serve as a reaction vessel, and a number of samples stored in the blending tube 10 may react. For example, the blending tube 10 may also serve as a vessel for both centrifugal separation and sample mixing (e.g., the Escherichia coli culture solution is centrifugally separated in the blending tube 10 to obtain the Escherichia coli sludge, and then the Escherichia coli sludge is mixed with the cell resuspension solution).

In some embodiments, the sample may include two or more substances to be mixed, for example, the sample may include the Escherichia coli sludge and the cell resuspension solution.

The first stirring member 30 and the second stirring member 40 may be configured to impact and stir the sample when the sample in the tube body 20 moves under the action of inertia and a centrifugal force. Impact and stirring may cause more vigorous movement of the substances in the sample, which accelerates the mixing and improves the mixing effect of the substances.

As shown in FIG. 3, in some embodiments, the ratio of width X1 to thickness Y1 of the first stirring member 30 is greater than 3. In some embodiments, the ratio of width X1 to thickness Y1 of the first stirring member 30 ranges from 3 to 20. In some embodiments, the ratio of width X1 to thickness Y1 of the first stirring member 30 ranges from 3 to 15. In some embodiments, the ratio of width X1 to thickness Y1 of the first stirring member 30 ranges from 3 to 10. In some embodiments, the ratio of width X1 to thickness Y1 of the first stirring member ranges from 3 to 4.

In some embodiments, the first stirring member 30 may have a width X1 within the range of 1.5 mm to 15 mm, and a thickness Y1 within the range of 0.5 mm to 3 mm. In some embodiments, the first stirring member 30 may have a width X1 within the range of 2.5 mm to mm, and a thickness Y1 within the range of 0.75 mm to 2 mm. In some embodiments, the first stirring member 30 may have a width X1 within the range of 3.5 mm to 5 mm, and a thickness Y1 within the range of 1 mm to 1.5 mm. Preferably, in some embodiments, the first stirring member 30 may have a width X1 of 3.5 mm, and the first stirring member 30 may have a thickness Y1 within the range of 1 mm to 1.2 mm.

In some embodiments, the ratio of width X2 to thickness Y2 of the second stirring member 40 is less than 1.5. In some embodiments, the ratio of width X2 to thickness Y2 of the second stirring member 40 ranges from 0.1 to 1.5. In some embodiments, the ratio of width X2 to thickness Y2 of the second stirring member 40 ranges from 0.5 to 1.5. In some embodiments, the ratio of width X2 to thickness Y2 of the second stirring member 40 ranges from 0.75 to 1.5. In some embodiments, the ratio of width X2 to thickness Y2 of the second stirring member 40 ranges from 1 to 1.5.

In some embodiments, the second stirring member 40 may have a width X2 within the range of 1 mm to 3 mm, and the second stirring member 40 may have a thickness Y2 within the range of 0.6 mm to 2 mm. In some embodiments, the second stirring member 40 may have a width X2 within the range of 1.2 mm to 2.5 mm, and the second stirring member 40 may have a thickness Y2 within the range of 0.8 mm to 1.8 mm. In some embodiments, the second stirring member 40 may have a width X2 within the range of 1.4 mm to 2 mm, and the second stirring member 40 may have a thickness Y2 within the range of 1 mm to 1.6 mm. In some embodiments, the second stirring member 40 may have a width X2 within the range of 1.6 mm to 1.9 mm, and the second stirring member 40 may have a thickness Y2 within the range of 1.2 mm to 1.4 mm. In some preferred embodiments, the second stirring member 40 may have a width X2 of 1.8 mm, and the second stirring member 40 may have a thickness Y2 within the range of 1.2 mm to 1.4 mm.

In some embodiments, the cross-sectional shape of the stirring rib may be in various forms, including but not limited to a triangle-like form (i.e., a triangle with an arc on one side), a trapezoid-like form (i.e., a trapezoid with an arc on one side) or a rectangle-like form (i.e., a rectangle with an arc on one side).

In some embodiments, the difference between the ratio of width X1 to thickness Y1 of the first stirring member 30 and the ratio of width X2 to thickness Y2 of the second stirring member 40 is within the range of 0.5 to 5. In some embodiments, the difference between the ratio of width X1 to thickness Y1 of the first stirring member 30 and the ratio of width X2 to thickness Y2 of the second stirring member 40 is within the range of 1 to 4. In some embodiments, the difference between the ratio of width X1 to thickness Y1 of the first stirring member 30 and the ratio of width X2 to thickness Y2 of the second stirring member 40 is within the range of 1.5 to 3. In some preferred embodiments, the difference between the ratio of width X1 to thickness Y1 of the first stirring member 30 and the ratio of width X2 to thickness Y2 of the second stirring member 40 is within the range of 1.5 to 2.

In some embodiments, the ratio of width X1 to thickness Y1 of the first stirring member 30 to the ratio of width X2 to thickness Y2 of the second stirring member 40 have a ratio within the range of 1 to 5. In some embodiments, the ratio of width X1 to thickness Y1 of the first stirring member 30 to the ratio of width X2 to thickness Y2 of the second stirring member 40 have a ratio within the range of 1.5 to 4. Preferably, in some embodiments, the ratio of width X1 to thickness Y1 of the first stirring member 30 to the ratio of width X2 to thickness Y2 of the second stirring member 40 have a ratio within the range of 2 to 3.

In some embodiments, the width X1 of the first stirring member 30 may be greater than the width X2 of the second stirring member 40, so that the mixing effect can be improved.

In some embodiments, the first stirring member 30 may have a width X1 within the range of 1.5 mm to 15 mm. In some embodiments, the first stirring member 30 may have a width X1 within the range of 2.5 mm to 10 mm. In some embodiments, the first stirring member 30 may have a width X1 within the range of 3.5 mm to 5 mm. Preferably, in some embodiments, the first stirring member 30 may have a width X1 of 3.5 mm.

In some embodiments, the second stirring member 40 may have a width X2 within the range of 1 mm to 3 mm. In some embodiments, the second stirring member 40 may have a width X2 within the range of 1.2 mm to 2.5 mm. In some embodiments, the second stirring member 40 may have a width X2 within the range of 1.4 mm to 2 mm. In some embodiments, the second stirring member 40 may have a width X2 within the range of 1.6 mm to 1.8 mm. Preferably, in some embodiments, the second stirring member 40 may have a width X2 of 1.8 mm.

In some embodiments, the difference between the width X1 of the first stirring member 30 and the width X2 of the second stirring member 40 may be within the range of 0.5 mm to 14 mm. In some embodiments, the difference between the width X1 of the first stirring member 30 and the width X2 of the second stirring member 40 may be within the range of 1 mm to 10 mm. In some embodiments, the difference between the width X1 of the first stirring member 30 and the width X2 of the second stirring member 40 may be within the range of 1.25 mm to 5 mm. In some embodiments, the difference between the width X1 of the first stirring member 30 and the width X2 of the second stirring member 40 may be within the range of 1.5 mm to 2 mm. Preferably, in some embodiments, the difference between the width X1 of the first stirring member 30 and the width X2 of the second stirring member 40 may be 1.7 mm.

In some embodiments, the ratio of the width X1 of the first stirring member 30 to the width X2 of the second stirring member 40 is within the range of 1 to 5. In some embodiments, the ratio of the width X1 of the first stirring member 30 to the width X2 of the second stirring member 40 is within the range of 1.25 to 3. In some embodiments, the ratio of the width X1 of the first stirring member 30 to the width X2 of the second stirring member 40 is within the range of 1.5 to 2.5. Preferably, in some embodiments, the ratio of the width X1 of the first stirring member 30 to the width X2 of the second stirring member 40 is within the range of 1.75 to 2.

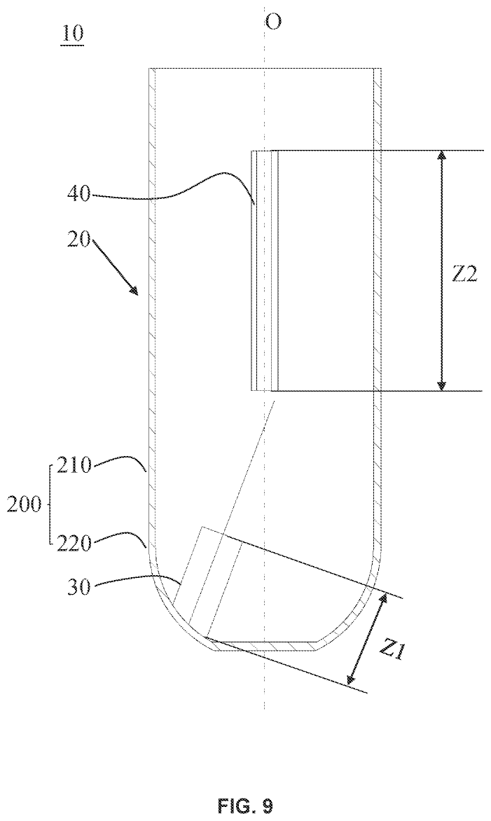

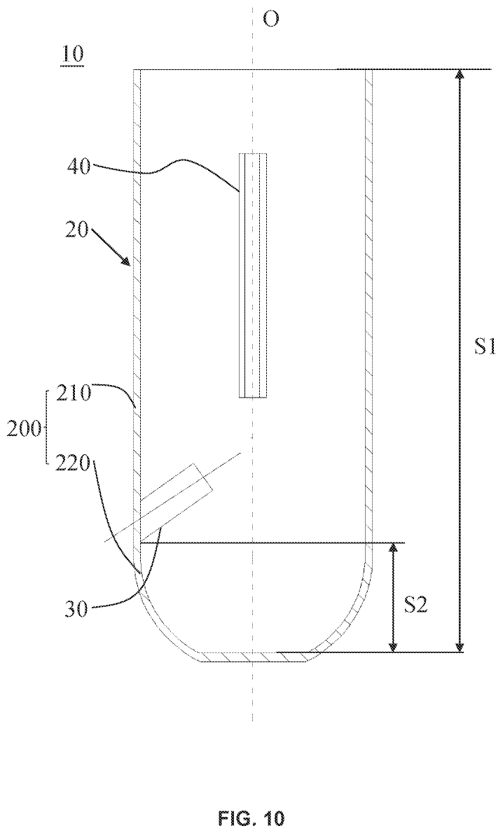

In some embodiments, the height of the first stirring member 30 and the height of the second stirring member 40 are related to the amount of samples to be mixed and a total length S1 (as shown in FIG. 10) of the tube body 20. In some embodiments, the height of the stirring member may refer to the dimension in a direction in which the stirring member extends near the bottom of the tube body 20 and away from the top of the tube body 20. For example, in FIG. 9, the first stirring member 30 has a height of Z1, and the second stirring member 40 has a height of Z2.

In some embodiments, the first stirring member 30 may have a height Z1 within the range of 5 mm to 100 mm. In some embodiments, the first stirring member 30 may have a height Z1 within the range of 10 mm to 75 mm. In some embodiments, the first stirring member 30 may have a height Z1 within the range of 15 mm to 50 mm. Preferably, in some embodiments, the first stirring member 30 may have a height Z1 of 15 mm. In some embodiments, the second stirring member 40 may have a height Z2 within the range of 10 mm to 100 mm. In some embodiments, the second stirring member 40 may have a height Z2 within the range of 30 mm to mm. In some embodiments, the second stirring member 40 may have a height Z2 within the range of 50 mm to 80 mm. In some embodiments, the second stirring member 40 may have a height Z2 within the range of 60 mm to 70 mm. Preferably, in some embodiments, the second stirring member 40 may have a height Z2 of 60 mm.

With reference to FIGS. 1, 3 and 6, in some embodiments, the inner wall 200 of the tube body 20 may include an inner side wall 210 and an inner bottom wall 220 hermetically connected to one end of the inner side wall 210; and the first stirring member 30 may be arranged on the inner bottom wall 220, and the second stirring member 40 may be arranged on the inner side wall 210. The first stirring member 30 and the second stirring member 40 may respectively impact and stir the substances in different areas of the blending tube 10 to cause more vigorous movement of the sample. Still taking the sample including Escherichia coli sludge and a cell resuspension solution as an example, the Escherichia coli sludge, due to its high specific gravity, will accumulate primarily in a bottom area of the blending tube 10, i.e., at the inner bottom wall 220; whereas the cell resuspension solution, due to its low specific gravity, will be located primarily in an area of the blending tube 10 other than the bottom, e.g., an area corresponding to the inner side wall 210. As the blending tube 10 rotates, the Escherichia coli sludge will move under the action of a centrifugal force and inertia, and the first stirring member will impact and stir the Escherichia coli sludge, causing it to move more vigorously. Similarly, the cell resuspension solution will also move under the action of the centrifugal force and inertia, and the second stirring member 40 will impact and stir the cell resuspension solution, so that the cell resuspension solution oscillates to produce a vortex and turbulence, thereby causing the cell resuspension solution to impact the Escherichia coli sludge to achieve adequate mixing.

In some embodiments, the first stirring member 30 and the second stirring member 40 may be circumferentially arranged along the inner wall 200 of the tube body 20. In some embodiments, the first stirring member 30 and the second stirring member 40 may be arranged at intervals. In this embodiment, the first stirring member 30 and the second stirring member 40 are circumferentially arranged at intervals along the inner wall 200 of the tube body 20, which can effectively improve the mixing effect of two or more substances in the sample.

In some embodiments, the blending tube 10 may be used in conjunction with an external apparatus (for example, a blending apparatus) to improve the mixing effect of the sample. In some embodiments, when the blending apparatus performs angular rotor rotation (i.e., the blending tube 10 is tilted at a certain angle and then rotated), the Escherichia coli sludge primarily accumulates on one side of the inner wall 200. If there is no gap 50 between the first stirring member 30 and the inner wall 200, a dead space will be formed, and the Escherichia coli sludge will accumulate in the dead space and will not be adequately mixed with the cell resuspension solution.

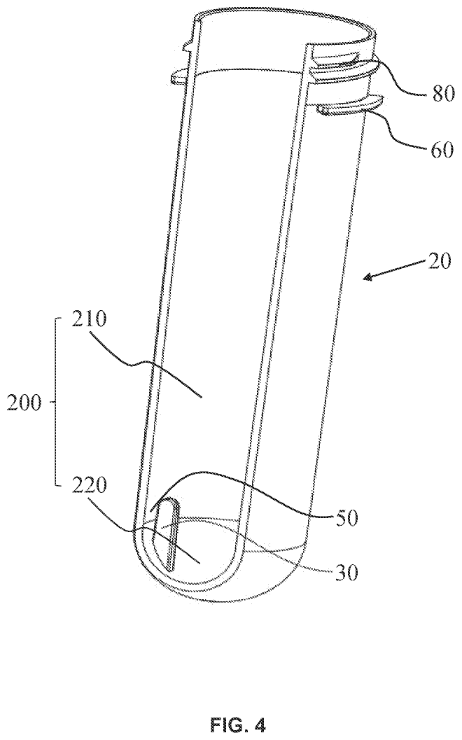

In some embodiments, a gap 50 may be formed between the first stirring member 30 and the inner wall 200 of the tube body 20 in a width direction. As shown in FIGS. 1 and 4, because of the presence of the gap 50, there will be no dead space between the first mixing member 30 and the inner wall 200, which can effectively avoid accumulation of the Escherichia coli sludge and improve the mixing effect.

In some embodiments, the gap 50 between the first stirring member 30 and the inner wall 200 of the tube body 20 in the width direction may have a length H no greater than 10 mm. In some embodiments, the gap 50 between the first stirring member 30 and the inner wall 200 of the tube body 20 in the width direction may have a length H within the range of 1 mm to 6 mm. In some embodiments, the gap 50 between the first stirring member 30 and the inner wall 200 of the tube body 20 in the width direction may have a length H within the range of 1.5 mm to 3 mm. In some embodiments, the gap 50 between the first stirring member 30 and the inner wall 200 of the tube body 20 in the width direction may have a length H of 2 mm.

In some embodiments, the first stirring member 30 may include a first end and a second end, the first end may be connected to the inner wall 200 of the tube body 20, and the second end extends in a direction parallel to a central axis O (as shown in FIGS. 9 and 10) of the tube body 20.

As shown in FIG. 9, in some embodiments, the second end of the first stirring member 30 may extend towards the center of the tube body 20, i.e., the extension direction of the first mixing member 30 and the direction of the central axis O of the tube body 20 form a certain angle to further improve the mixing effect.

In some embodiments, the first end of the first stirring member 30 may be connected to the inner bottom wall 220 of the tube body 20. For example, in the embodiments shown in FIGS. 1 and 9, the first end of the first stirring member 30 is connected to the inner bottom wall 220.

As shown in FIG. 10, in some embodiments, the first end of the first stirring member 30 may be connected to the end of the inner side wall 210 of the tube body 20 close to the inner bottom wall 220. In some embodiments, when the first end of the first stirring member 30 may be connected to the inner side wall 210 of the tube body 20, the distance S2 between the first end of the first stirring member 30 and the bottom of the inner bottom wall 220 may be 1/7 to ⅓ of the total length S1 of the tube body 20. In some embodiments, the distance S2 between the first end of the first stirring member 30 and the bottom of the inner bottom wall 220 may be ⅙ to ⅓ of the total length S1 of the tube body 20. Preferably, in some embodiments, the distance S2 between the first end of the first stirring member 30 and the bottom of the inner bottom wall 220 may be ⅕ to ⅓ of the total length S1 of the tube body 20.

Furthermore, in order to reduce accumulation of the solid substances at the joint between the first stirring member 30 and the inner bottom wall 220 of the tube body 20, in some embodiments, the first stirring member 30 may also be configured to be, in its width direction, smoothly connected to the inner bottom wall 220 of the tube body 20, i.e., the joint in the width direction is provided with a fillet.

In some embodiments, the first stirring member 30 and the second stirring member 40 may impact the sample, thereby causing a more vigorous movement of the sample and improving the effect of mixing between the substances. The impact on the mixing effect from the disposing positions and the specific structures of the first stirring member 30 and the second stirring member 40 are described in one or more of the preceding embodiments. In addition, in some embodiments, the number of the first stirring members 30 and the number of the second stirring members 40 may also affect the mixing effect of the substances.

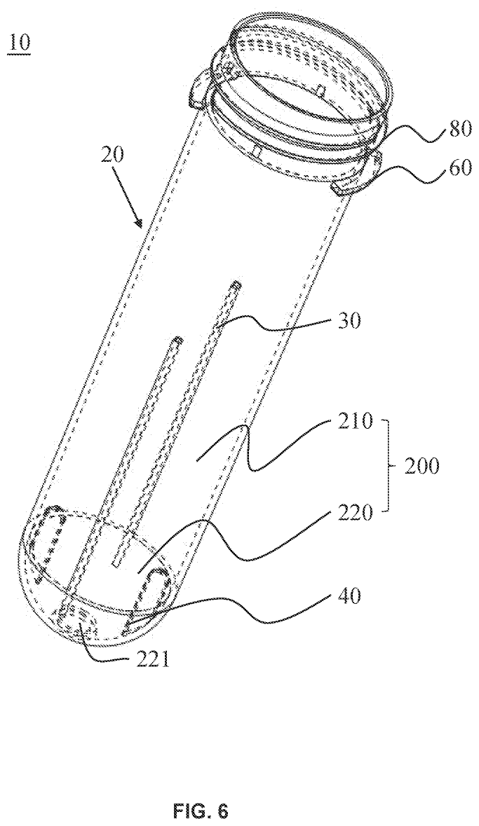

As shown in FIG. 6, in some embodiments, there may be two of the first stirring members 30 and two of the second stirring members 40. In this embodiment, due to increase of the number of the first stirring members 30 and the number of the second stirring members 40, a liquid (for example, the cell resuspension solution) is impacted and stirred by the two second stirring members 40 under the action of inertia and a centrifugal force, thereby producing more intense vortexes and turbulence. At the same time, the Escherichia coli sludge will also be impacted and stirred by the two first stirring members 30, and the movement produced will be more vigorous. Therefore, the Escherichia coli sludge and the cell resuspension solution will be mixed more adequately, and the mixing rate will be higher.

In some embodiments, the number of the first stirring members 30 and the number of the second stirring members 40 are not limited to two, but may both be one, three, four or more. For example, in the embodiment shown in FIG. 9, the number of the first stirring member 30 and the number of the second stirring member 40 may both be one.

In some embodiments, the number of the first stirring members 30 and the number of the second stirring members 40 may be the same. For example, there may be two of the first stirring members 30 and two of the second stirring members 40 as shown in FIG. 3 and FIG. 6. For example, in the embodiment shown in FIG. 9, the number of the first stirring member 30 and the number of the second stirring member 40 may both be one.

In some embodiments, the number of the first stirring members 30 and the number of the second stirring members 40 may be different. For example, the number of the first stirring member 30 is one, and the number of the second stirring members 40 is two. For example, the number of the first stirring members 30 is two, and the number of the second stirring members is four.

In some embodiments, the first stirring member 30 and the number of the second stirring members 40 are arranged in a way associated with the number of the first stirring members 30 and the number of the second stirring members 40. As shown in FIGS. 3, 6 and 9, in some embodiments, the two first stirring members 30 and the two second stirring members 40 may both be symmetrically arranged with respect to the central axis O of the tube body 20. In this embodiment, due to the symmetrical arrangement, the two second stirring members 40 may simultaneously impact and stir the cell resuspension solution, and the two first stirring members may also impact and stir the Escherichia coli sludge at the same time, so that the cell resuspension solution and the Escherichia coli sludge can be mixed more uniformly, which improves the mixing effect of the sample. Moreover, the vortex and turbulence produced when each second stirring member 40 impacts the cell resuspension solution may not affect each other, which further improves the mixing effect.

In addition, in some embodiments, when the number of the first stirring members 30 is three, the three first stirring members 30 may be arranged around the inner bottom wall 220 at regular intervals, i.e., connecting lines between every two adjacent first stirring members 30 and the central axis O of the tube body 20 form an angle of 120 degrees. In some embodiments, when the number of the first stirring members 30 is four, the four first stirring members may also be arranged around the inner bottom wall 220 at regular intervals, i.e., connecting lines between every two adjacent first stirring members 30 and the central axis O of the tube body 20 form an angle of 90 degrees. Similarly, for the design of the second stirring member 40, a reference may be made to the descriptions of the embodiment of the first stirring member 30. For example, when the number of the second stirring members 40 is three, the three second stirring members may be arranged around the inner side wall 210 at regular intervals, and connecting lines between every two adjacent second stirring members 40 and the central axis O of the tube body form an angle of 120 degrees. For example, when the number of the second stirring members is four, the four second stirring members 40 may also be arranged around the inner side wall 210 at regular intervals, and connecting lines between every two adjacent second stirring members 40 and the central axis O of the tube body 20 form an angle of 90 degrees.

It should be noted that the way of arranging the first stirring member 30 and the second stirring member 40 is only illustrated as an example in this embodiment, and the way of arranging the first stirring member 30 and the second stirring member 40 may be improved after a good grasp of the principle of the blending tube 10. For example, the two first stirring members may be symmetrically arranged with respect to the central axis O of the tube body 20, while the second stirring members 40 are not symmetrical with respect to the central axis O of the tube body 20. For example, the number of the first stirring members 30 is four, and the number of the second stirring members 40 is three. The three second stirring members 40 may be arranged around the inner side wall 210 at regular intervals, while the four first stirring members 30 may be arranged around the inner bottom wall 220 at different intervals. Such variations are within the scope of protection of the present application.

FIG. 3 exemplarily shows an embodiment in which the connecting line between the two first stirring members 30 and the connecting line between the two second stirring members 40 forms an angle β of 90 degrees. As shown in FIGS. 3 and 6, in some embodiments, the mixing effect of the sample is also related to the angle formed by the connecting line between the two first stirring members 30 and the connecting line between the two second stirring members 40. In some embodiments, the connecting line between the two first stirring members 30 and the connecting line between the two second stirring members 40 form an angle β ranging from 30 degrees to 90 degrees. In some embodiments, the connecting line between the two first stirring members 30 and the connecting line between the two second stirring members 40 form an angle β ranging from 45 degrees to 90 degrees. In some embodiments, the connecting line between the two first stirring members 30 and the connecting line between the two second stirring members form an angle β ranging from 60 degrees to 90 degrees. In some preferred embodiments, the connecting line between the two first stirring members 30 and the connecting line between the two second stirring members 40 form an angle β of 90 degrees.

In some embodiments, when the number of the first stirring members 30 and the number of the second stirring members 40 are both three, the three first stirring members 30 may be arranged around the inner bottom wall 220 at regular intervals, the three second stirring members may be arranged around the inner side wall 210 at regular intervals, and a connecting line between the first stirring member 30 and the central axis O of the tube body 20 and a connecting line between the second stirring member 40 and the central axis O of the tube body 20 may form an angle of 60 degrees. In some embodiments, when the number of the first stirring members 30 and the number of the second stirring members are both four, the four first stirring members 30 may be arranged around the inner bottom wall 220 at regular intervals, the four second stirring members 40 may be arranged around the inner side wall 210 at regular intervals, and a connecting line between the first stirring member 30 and the central axis O of the tube body 20 and a connecting line between the second stirring member 40 and the central axis O of the tube body 20 may form an angle of 45 degrees.

In some embodiments, if the number of the first stirring members 30 and the number of the second stirring members 40 are different, for example, when the number of the first stirring members 30 is four, and the number of the second stirring members 40 is two, the two first stirring members 30 may be symmetrically arranged on the inner bottom wall 220 with respect to the central axis O of the tube body 20, the four second stirring members 40 may be arranged around the inner side wall 210 at regular intervals, and a connecting line between the first stirring member 30 and the central axis O of the tube body 20 and a connecting line between the second stirring member 40 and the central axis O of the tube body 20 may form an angle of 30 degrees. For example, when the number of the first stirring member 30 is one, and the number of the second stirring members 40 is two, the two second stirring members 40 may be symmetrically arranged on the inner side wall 210 with respect to the central axis O of the tube body 20, and a connecting line between the first stirring member 30 and the central axis O of the tube body 20 and a connecting line between the two second stirring members 40 may form an angle of 90 degrees.

In some embodiments, the first stirring member 30 and the second stirring member 40 may be made of the same material as the tube body 20, including polyethylene, polycarbonate, polypropylene and the like. In some embodiments, the first stirring member 30, the second stirring member 40 and the tube body 20 may be integrally molded, or may be separately molded and then assembled.

In some embodiments, the blending tube 10 may only include the first stirring member and the first stirring member 30 may be circumferentially arranged along the inner wall 200 of the tube body 20. The purpose of impacting and stirring the sample to improve the mixing effect can be achieved by the first stirring member 30. In other embodiments, the blending tube may only include the first stirring member 30, the first stirring member 30 may be circumferentially arranged along the inner wall 200 of the tube body 20, and a gap 50 is formed between the first stirring member 30 and the inner wall 200 of the tube body 20 in the width direction. When the blending tube 10 only includes the first stirring member 30, the number of the first stirring members 30 may be one, two, three or more. A reference may be made to the descriptions of other embodiments of the present application for the way in which the one or more first stirring members 30 are arranged, which will not be repeated herein. When the blending tube 1 only includes the first stirring member 30, a reference may be made to the descriptions of the first stirring member 30 in other embodiments of the specification for relevant designs, including the width, thickness, width-to-thickness ratio and height of the first stirring member 30, and the disposing position of the first stirring member 30, which will not be repeated herein.

In some embodiments, the mixing of the substances mainly depends on the centrifugal force generated by the reciprocating rotational motion of the blending tube 10 and the inertia of the sample, which causes the substances to move and to be further impacted and stirred by the first stirring member 30 and the second stirring member 40 to achieve mixing. It can be understood that the closer is to the central axis O of the blending tube 10, the smaller the centrifugal force and the inertia force will be during rotation of the blending tube 10. In some embodiments, the inner bottom wall 220 of the tube body 20 may protrude outwards in the direction away from the tube body 20 to form a cone. If the apex angle of the cone is small in a plane where its generatrix is located, the Escherichia coli sludge may accumulate more easily at the bottom of the inner bottom wall 220 and fail to be adequately mixed with the cell resuspension solution, which reduces the mixing effect.

The bottom of the inner bottom wall 220 may be designed to avoid accumulation of the Escherichia coli sludge and to improve the mixing effect. In some embodiments, the inner bottom wall 220 may be set to protrude outwards in the direction away from the tube body 20 to form a cone, and the apex angle of the cone is made greater than 90 degrees in a plane where its generatrix is located. In some embodiments, the bottom of the inner bottom wall 220 may be set as a flat face, i.e., the tube body 20 has a flat bottom, as shown in FIGS. 9 and 10. When the tube body 20 has a flat bottom, the accumulation of the Escherichia coli sludge at the bottom can be effectively reduced. In some embodiments, the bottom of the inner bottom wall 220 may be set as an upwardly convex face. The so-called upwardly convex face may mean that the bottom of the inner bottom wall 220 protrudes towards the inside of the tube body 20. Since the bottom of the inner bottom wall 220 protrudes upwards (i.e., the inside of the tube body 20), the Escherichia coli sludge may not accumulate on the upwardly convex face even though it is subjected to a small centrifugal force and a small inertia force.

In some embodiments, in addition to the structural design of the bottom of the inner bottom wall 220, a bulged portion 221 protruding towards the inside of the tube body 20 may be arranged at the bottom of the inner bottom wall 220 to prevent accumulation of the Escherichia coli sludge and to improve the mixing effect. In some embodiments, the shape of the bulged portion 221 may be a cone, a cylinder, a hemisphere, a semi-elliptical sphere, etc., or a combination thereof. For example, the bulged portion 221 may be a cone. For example, the bulged portion 221 may be a hemisphere.

In some embodiments, the joint between an edge of the bulged portion 221 and the inner bottom wall 220 may be a smooth joint, i.e., the joint is curved, so as to avoid accumulation of the Escherichia coli sludge at the joint between the bulged portion 221 and the inner bottom wall 220 and improve the mixing effect.

It should be noted that the bulged portion 221 may be combined with the structure related to the bottom of the inner bottom wall 220 in one or more of the aforementioned embodiments. For example, the bottom of the inner bottom wall 220 may be a flat face, and moreover, the bottom of the inner bottom wall 220 is also provided with the bulged portion 221 protruding towards the inside of the tube body 20.

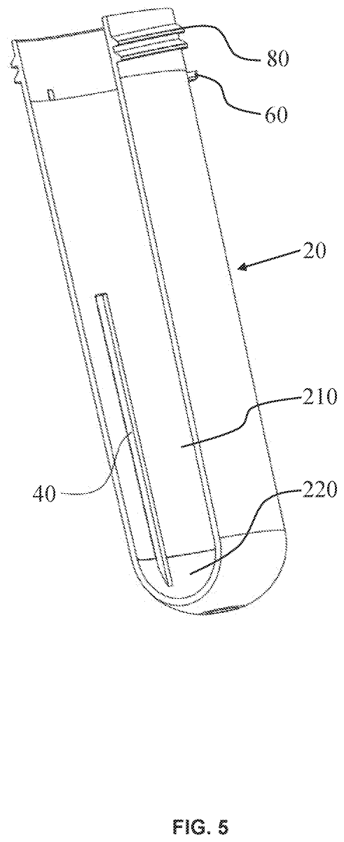

Referring to FIGS. 4 to 6, in some embodiments, an outer wall of the tube body 20 may be provided with an anti-rotating portion, and the anti-rotating portion may be configured to prevent the blending tube 10 from moving relative to an external apparatus after the blending tube 10 is fitted with the external apparatus. The external apparatus herein differs according to different uses of the blending tube 10. For example, the external apparatus may be a blending apparatus when the sample in the blending tube 10 needs to be mixed. For example, the external apparatus may be a centrifugal apparatus when the sample in the blending tube 10 needs to be centrifugally separated.

In some embodiments, the anti-rotating portion may include a first anti-rotating portion 60 disposed at the end of the outer wall of the tube body 20 away from the inner bottom wall 220. In some embodiments, the first anti-rotating portion 60 may be a flange arranged around the outer wall of the tube body 20 (as shown in FIG. 4). When the blending tube 10 is fitted with the external apparatus, the flange may also be fitted with the external apparatus to ensure that the blending tube 10 will not disengage when rotating under the drive of the external apparatus.

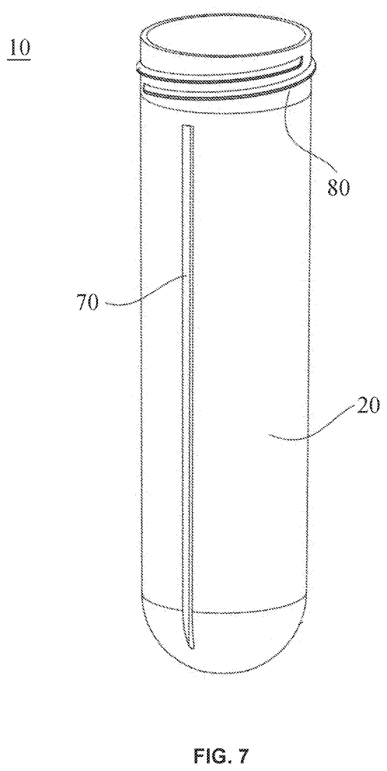

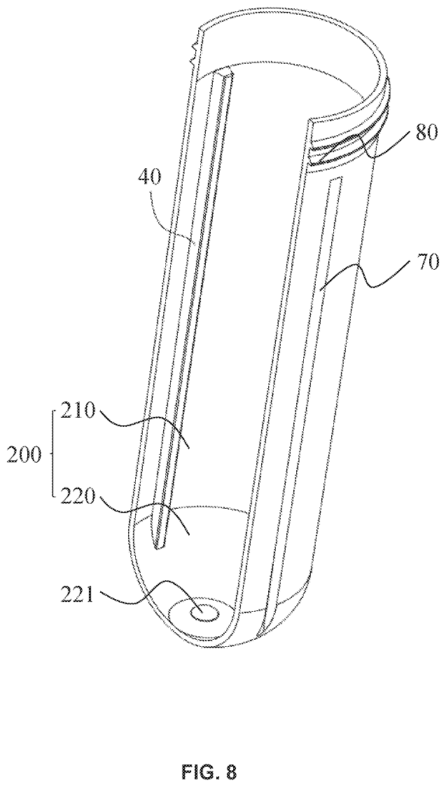

As shown in FIGS. 7 and 8, in some embodiments, the anti-rotating portion may further include a second anti-rotating portion 70 disposed on an outer side wall of the tube body 20. In some embodiments, the second anti-rotating portion 70 may be a groove arranged in the axial direction of the tube body 20. In some embodiments, the groove may be fitted with a buckle of the external apparatus, thereby ensuring relative fixation of the blending tube 10 to the external apparatus. In some embodiments, the second anti-rotating portion 70 may further include a strip-shaped projection arranged in the axial direction of the tube body 20 (as shown in FIG. 7). The strip-shaped projection may be fitted with a clamping groove of the external apparatus to secure the blending tube 10 to the external apparatus.

In some embodiments, the blending tube 10 may further include a top cover (not shown in the figures), and the top cover may cover an open end of the tube body 20 (i.e., the end of the inner side wall 210 away from the inner bottom wall 220). In some embodiments, the top cover and the blending tube 10 may be fitted in various ways, including but not limited to, thread 80 connection, snap connection, and the like. For example, the end of the outer wall of the tube body 20 away from the inner bottom wall 220 is provided with a thread 80, the inner wall of the top cover 200 is provided with a thread 80 groove, and the top cover and the tube body 20 are connected by means of the thread 80 and the thread 80 groove.

The possible beneficial effects of the embodiments of the present application include but are not limited to the following aspects: (1) the first stirring member and the second stirring member with different width-to-thickness ratios or different widths are arranged on the inner wall to simultaneously impact and stir the substances located in different areas of the tube body, so that the mixing speed and the mixing effect are improved; (2) the two first stirring members and the two second stirring members are symmetrically arranged with respect to the central axis of the tube body, so that vortexes and turbulence produced when each second stirring member impacts the cell resuspension solution do not affect each other; (3) the number of the first stirring members and the number of the second stirring members are both set to two, so that the sample, when moving, will be impacted and stirred by the two first stirring members and the two second stirring members, respectively, thereby improving the mixing effect; (4) an angle formed by the connecting line between the two first stirring members and the connecting line between the two second stirring members is set to 90 degrees, so that vortexes and turbulence produced when each second stirring member impacts the cell resuspension solution do not affect each other; (5) the anti-rotating portion is arranged on the outer wall of the tube body, so that when the blending tube is fitted with the external apparatus, the anti-rotating portion may also be fitted with the external apparatus to secure the blending tube to the external apparatus, which ensures that the blending tube will not disengage when rotating under the drive of the external apparatus; and (6) the bottom of the tube body is set as a flat bottom or an upwardly concave face, so that the solid substances accumulated at the bottom are reduced and the substances are mixed more uniformly. It should be noted that different embodiments may have different beneficial effects, and the beneficial effects that may be produced in the different embodiments may be any one or a combination of the above, or may be any other beneficial effects that may be obtained.

The basic concepts have been described above, and it will be apparent to those skilled in the art that the foregoing detailed disclosure is intended to be exemplary only and does not constitute a limitation to the present application. Although not explicitly stated herein, those skilled in the art may make various modifications, improvements and amendments to the present application. Such modifications, improvements and amendments are suggested in the present application, and thus remain within the spirit and scope of the exemplary embodiments of the present application.

Meanwhile, the present application uses specific words to describe the embodiments of the present application. For example, “one embodiment”, “an embodiment” and/or “some embodiments” means a particular feature, structure or characteristic related to at least one embodiment of the present application. Therefore, it should be emphasized and noted that “an embodiment” or “one embodiment” mentioned twice or more in different places of the present application does not necessarily refer to the same embodiment. Furthermore, some features, structures or characteristics in one or more embodiments of the present application may be appropriately combined.

Furthermore, unless explicitly stated in the claims, the order of processing elements and sequences, the use of numbers and letters, or the use of other names described in the present application is not intended to limit the order of the process or method of the present application. Although some currently considered useful embodiments of the invention have been discussed in the above disclosure by way of various examples, it should be understood that such details are only for illustrative purposes, and that the appended claims are not limited to the disclosed embodiments; rather, the claims are intended to cover all amendments and equivalent combinations that are in line with the spirit and scope of the embodiments of the present application. For example, although the system components described above can be implemented by means of hardware devices, they may also be implemented only by software solutions, such as installing the described system on an existing server or mobile device.

Similarly, it should be noted that in order to simplify the presentation of the disclosure of the present application, and thereby help to understand one or more embodiments of the invention, in the previous descriptions of the embodiments of the present application, various features are sometimes combined into one embodiment, the accompanying drawings, or descriptions thereof. However, this method of disclosure does not imply that the subject of the present application requires more features than those mentioned in the claims. In fact, the embodiments have fewer features than all of the individual embodiments disclosed above.

Finally, it should be understood that the embodiments described in the present application are only intended to illustrate the principles of the embodiments of the present application. Other variations may also fall within the scope of the present application. Thus, by way of example but not limitation, alternative configurations of the embodiments of the present application can be considered consistent with the teachings of the present application. Accordingly, the embodiments of the present application are not limited to those explicitly presented and described herein.

What is claimed is:

1. A blending tube, comprising:
a tube body, the tube body being used for accommodating a sample; and
a first stirring member and a second stirring member, which are arranged on an inner wall of the tube body, wherein a width-to-thickness ratio of the first stirring member is greater than a width-to-thickness ratio of the second stirring member.

2. The blending tube according to claim 1, wherein the width-to-thickness ratio of the first stirring member is greater than 3.

3. The blending tube according to claim 1, wherein the first stirring member has a width within the range of 3.5 mm to 5 mm, and the first stirring member has a thickness within the range of 1 mm to 1.2 mm.

4. The blending tube according to claim 1, wherein the width-to-thickness ratio of the second stirring member is less than 1.5.

5. The blending tube according to claim 1, wherein the second stirring member has a width within the range of 1.6 mm to 1.9 mm, and the second stirring member has a thickness within the range of 1.2 mm to 1.4 mm.

6. The blending tube according to claim 1, wherein the first stirring member has a height within the range of 5 mm to 100 mm.

7. The blending tube according to claim 1, wherein the second stirring member has a height within the range of 10 mm to 100 mm.

8. The blending tube according to claim 1, wherein a gap is formed between the first stirring member and the inner wall of the tube body in a width direction.

9. The blending tube according to claim 8, wherein the gap has a length no greater than 10 mm.

10. The blending tube according to claim 1, wherein the inner wall of the tube body comprises an inner side wall and an inner bottom wall hermetically connected to one end of the inner side wall; and
the first stirring member is arranged on the inner bottom wall, and the second stirring member is arranged on the inner side wall.

11. The blending tube according to claim 10, wherein the bottom of the inner bottom wall is a flat face or an upwardly convex face, the upwardly convex face protruding towards the inside of the tube body.

12. The blending tube according to claim 10, wherein the bottom of the inner bottom wall is provided with a bulged portion protruding towards the inside of the tube body.

13. The blending tube according to claim 1, wherein there are two of the first stirring members and two of the second stirring members.

14. The blending tube according to claim 13, wherein the two first stirring members and the two second stirring members are symmetrically arranged with respect to a central axis of the tube body.

15. The blending tube according to claim 14, wherein a connecting line between the two first stirring members and a connecting line between the two second stirring members form an angle of 90 degrees.

16. The blending tube according to claim 1, wherein the first stirring member and the second stirring member are circumferentially arranged at intervals along the inner wall of the tube body.

17. The blending tube according to claim 1, wherein the first stirring member comprises a first end and a second end, the first end being connected to the inner wall of the tube body, and the second end extending towards the center of the tube body.
